(19) United States
(12) Patent Application Publication
(10) Pub. No.: US 2025/0165604 A1
(43) Pub. Date: May 22, 2025

(54) SYSTEMS AND METHODS FOR IDENTIFYING ONE OR MORE DEFICIENCIES IN AN ELECTION SYSTEM

(71) Applicant: BOX13, LLC, Plantation, FL (US)

(72) Inventors: Rotem Grosman, Plantation, FL (US); Douglas BEFORT, Plantation, FL (US); Beckie J. Sirolli, Plantation, FL (US)

(21) Appl. No.: 18/943,112

(22) Filed: Nov. 11, 2024

Related U.S. Application Data
(60) Provisional application No. 63/548,170, filed on Nov. 11, 2023.

(51) Int. Cl. G06F 21/57

(52) U.S. Cl. CPC G06F 21/57

(57) ABSTRACT

Methods and systems for identifying one or more deficiencies in an election system can include providing remote access over a network to a non-transitory storage device for updating information about an election in real time; retrieving the information in a non-standardized format dependent on one or more hardware and software platforms of at least one election data source database; converting the non-standardized format into the standardized format; retrieving one or more legal framework records and converting as the standardized format into the content server; generating one or more compliance rules; comparing the information with the one or more compliance rules to identify the one or more deficiencies in the election data source records; automatically generating a remedial message about the compared information of the election data source records by the content server; and transmitting the remedial message to a first user over the network in real time.

### CROSS-REFERENCE TO RELATED APPLICATIONS

This application claims the benefit of U.S. Provisional Application No. 63/548,170, filed on Nov. 11, 2023, and entitled “SYSTEMS AND METHODS FOR ASSESSING ELECTION SYSTEM COMPLIANCE,” which is incorporated herein by reference in its entirety for all purposes.

### BACKGROUND

Regardless of the jurisdiction, elections are a foundational element of any society at least partially governed by democratic processes. To maintain maximum effectiveness, elections are conducted fairly. This means that ballots are only counted when they are received from registered, eligible voters in a particular jurisdiction, and that the voter rolls identifying such registered, eligible voters are properly maintained and updated in accordance with any applicable statutes, laws, regulations, or guidelines, among other things.

As technology plays an increasingly significant role in the daily lives of people all over the world, election processes have adopted many digital election systems and components that allow many aspects of conducting elections and maintaining voter rolls to be performed electronically. While these systems increase the convenience and efficiency of participating in elections, they generate and store a tremendous amount of data. Elected individuals charged with overseeing the completeness and accuracy of the data and maintaining the integrity of elections often lack the tools necessary to sufficiently monitor the data, confirm its completeness and accuracy, and verify that the associated election systems are operating in compliance with any relevant laws, rules, or other requirements.

### SUMMARY

These and other features will be more clearly understood from the following detailed description taken in conjunction with the accompanying drawings and claims.

In some embodiments, a method for identifying one or more deficiencies in an election system can include providing remote access over a network to a non-transitory storage device for updating information about an election in real time; retrieving the information in a non-standardized format dependent on one or more hardware and software platforms of at least one election data source database; converting, by a content server, the non-standardized format into the standardized format; and storing the information about election data source records in the standardized format within the content server. The method can further include retrieving one or more legal framework records and converting as the standardized format into the content server; generating one or more compliance rules; comparing the information in the standardized format with the one or more compliance rules to identify the one or more deficiencies in the election data source records; automatically generating a remedial message about the compared information of the election data source records by the content server after validating the information; and transmitting the remedial message to a first user over the network in real time.

In some embodiments, an election system for maintaining election integrity in at least one jurisdiction can include a content server. The content server can be configured to: receive information in a non-standardized format dependent on one or more hardware and software platforms from at least one election data source database containing information about elections in a non-standardized format, convert the non-standardized format into a standardized format, store the information about election data source records in the standardized format, compare the information in the standardized format with one or more compliance rules to identify one or more deficiencies in an election system, automatically generate a remedial message about a compared information of the election data source records by the content server after comparing the information, and transmit the remedial message to a first user comprising an election personnel over a computer network in real time.

In some embodiments, an election system for maintaining election integrity in at least one jurisdiction can include a content server. The content server can include a data mapping and standards engine to receive information in a non-standardized format dependent on one or more hardware and software platforms from at least one election data source database containing information about elections in a non-standardized format, and convert the non-standardized format into a standardized format, a standardized source database to store the information about election data source records in the standardized format, a compliance rules engine to compare the information in the standardized format with one or more compliance rules to identify one or more deficiencies in an election system, a compliance deficiency database to store one or more identified deficiencies in the election system, and a compliance deficiency alerts and reporting engine to automatically generate a remedial message about the one or more identified deficiencies, and transmit the remedial message to a first user comprising an election personnel over a computer network in real time.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates an election compliance assessment system, according to some embodiments.

FIG. 2A illustrates an exemplary graphical user interface for an election compliance assessment system, according to some embodiments.

FIG. 2B illustrates a graphical user interface for an election compliance assessment system, according to some embodiments.

FIG. 3 illustrates a graphical user interface for an election compliance assessment system, according to some embodiments.

FIG. 4 illustrates method steps for a process for assessing election system compliance, according to some embodiments.

FIG. 5 illustrates method steps for a process for assessing election system compliance, according to some embodiments.

FIG. 6 illustrates a flowchart depicting data flow through an election compliance assessment system, according to some embodiments.

FIG. 7 illustrates method steps for a process for assessing election system compliance, according to some embodiments.

FIG. 8 illustrates a block diagram of a computing system that may be useful for an election compliance assessment system, according to some embodiments

FIG. 9 illustrates a block diagram of a computer system of the disclosure, according to some embodiments.

FIG. 10. illustrates a chart depicting generally preferred election practices pre-election, during the election and post-election, according to some embodiments.

FIG. 11 illustrates a block diagram depicting an election system according to some embodiments.

FIGS. 12-17 illustrate various graphical user interfaces for an election system, according to some embodiments.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The present disclosure provides generally for systems and methods for assessing election system compliance. According to some embodiments, an election compliance assessment system may comprise at least one computing device, one or more databases, and one or more servers, wherein the computing device, the databases, and the servers may be communicatively coupled via at least one network connection. In some embodiments, systems and/or methods can include a content server configured to receive information, convert information, store information, compare information, automatically generate a remedial message, and/or transmit the remedial message. In some embodiments, the computing device and each of the servers may comprise one or more coded instructions or algorithms configured to facilitate at least one election compliance assessment. In some implementations, the coded instructions or algorithms may be configured to facilitate at least one election compliance assessment by using one or more rules, regulations, laws, or other parameters to analyze one or more results from a comparative analysis of data obtained or derived from one or more databases to determine whether such parameters are being satisfied or fulfilled.

By way of example and not limitation, the election compliance assessment system may be configured to perform a comparative analysis between data derived from at least one election system and one or more parameters comprising one or more statutes or other laws applicable to at least one electoral jurisdiction. In some aspects, the election compliance assessment system may be configured to present the results of such analysis to at least one elected official or similar authority figure responsible for overseeing one or more election processes, such as maintaining voter rolls or ensuring the integrity and accuracy of election processes, as non-limiting examples.

In some implementations, the election compliance assessment system may be configured to generate and provide at least one portal that may be accessible via at least one computing device by any public member of an election jurisdiction, thereby enabling the public to view one or more results of at least one election compliance assessment and receive insight in a transparent manner as to whether local elections are being conducted in accordance with any relevant laws or rules.

### Definitions

As used herein, a “parameter” can be any rule, regulation, law, guideline, opinion, or similar metric that may indicate one or more requirements to which at least one datum must conform. As a non-limiting illustrative example, a parameter may comprise a legal requirement that a registered voter should be changed from an active status to an inactive status (except during a statutory moratorium) upon the occurrence of one or more events, such as, for example and not limitation, upon a failure of the registered voter to respond to one or more official notices, mailers, or similar communications from an election office or an official representative thereof.

As used herein, a “legal framework record” can include, all or in part, any law, regulation, rule, federal and/or state constitution, federal and/or state legislative law, federal and/or state regulation, federal and/or state guideline, a rule derived from a federal and/or state judicial and/or agency opinion and/or decision, regulatory guidance, or any other legal decision, such those decisions made by the federal government, state government, county government, city government, or other administrative division that provides requirements for conducting an election in a jurisdiction. Usually, multiple legal framework records govern the procedures for conducting an election.

As used herein, a “user” can be any individual accessing the election system for identifying, and optionally remedying, deficiencies, and can include a member of the public, an election officer, such as an unelected chief election officer, or an elected official, such as an elected secretary of state, e.g., Secretary of State of Florida. The user can be compensated, employed, or a volunteer. An election personnel can be a user compensated and employed to supervise, directly or indirectly elections, whether elected or not. In some embodiments, a user can refer to any person, entity, machine, apparatus, device, or component that may utilize, engage, or interact with at least a portion of an election compliance assessment system or an election system (hereinafter may be collectively referred to in some embodiments as an “election system”). In some non-limiting exemplary embodiments, different types of users of the election system may comprise different levels of access permissions pertaining to the use of the election system. By way of example and not limitation, an automated user with unrestricted access may comprise one or more automated processes configured to occur within an election system without human interaction, a super user may comprise a human user that may obtain unrestricted access to an election system upon successfully submitting one or more login or similar authentication credentials (such as, for example and not limitation, an official from a department of state or a supervisor of elections), a permissions-confined user may comprise a human user that may obtain limited restricted access to one or more portions or features of an election system upon successfully submitting one or more login or similar authentication credentials (such as, for example and not limitation, an election staff member), and a read-only user may comprise a human user that may view or otherwise receive a limited number of one or more reports, summaries, or similar results or outputs from an election system without needing to log in or otherwise be authenticated (such as, for example and not limitation, a member of the general public).

As used herein, “voter registration data” can refer to any data related to or associated with a registered voter. By way of example and not limitation, voter registration data may comprise one or more of: the name, voter status (e.g., active, inactive, or ineligible), voter identification number, party affiliation, residential address, telephone number, date of birth, ethnicity, or sex of a registered voter, as well as whether the registered voter voted in one or more elections, the method the registered voter used to submit one or more ballots, or whether the registered voter signed one or more petitions. In some aspects, voter registration data may be stored in at least one voter registration database. In some non-limiting exemplary implementations, voter registration data may be generated by or may otherwise originate from a voter or an election staff member, as non-limiting examples.

As used herein, “election data” can refer to any data related to or associated with the execution, maintenance, or administration of at least one election system, record, and/or process. In some non-limiting exemplary embodiments, election data may be at least partially obtained or derived from one or more election systems comprising election software used to facilitate execution of at least one election, as well as data obtained or derived from a signature verification machine, vote tabulator apparatus, or similar election system component, as non-limiting examples. By way of example and not limitation, election data may comprise information pertaining to an identification of one or more voters who participated in an election, ballot information received from each voter, any relevant signature verification information, a date or timestamp when a ballot was cast or received, or a method via which a ballot was received or submitted. In some embodiments, “election data” may be used interchangeably with “election system data” referring to any data that may be used by, generated by, or otherwise associated with at least one election system and can include “voter registration data”.

As used herein, an “election system” can refer to any grouping or configuration of one or more hardware or software components that may be used by an election office or similar election facilitator to process, manage, administer, or otherwise facilitate at least one election, and may be referred to interchangeably in some embodiments with “election compliance assessment system”, or in some embodiments an “election system” or “election systems” may be a part of an “election compliance assessment system”.

As used herein, the term “during election” can mean the time during actual voting, and early voting, as well as optionally including a time, typically 90 days, before election day where purging of voter rolls is prohibited. Activities during this time period can include mail ballot signature verification, tabulation machine calibration, etc.

As used herein, the term “pre-election” can mean more than 90 days before election day, and can include activities such as voter roll maintenance, ballot style formulation, voter id distribution, logic and accuracy tests, etc.

As used herein, the term “post-election” can mean after election day and validation of the vote totals for the election conducted on election day. Post-election activities can include auditing and certification.

As used herein, the term “non-transitory storage device” can mean any type of storage medium that retains data even when it is not powered, as distinguished from temporary (transitory) storage. Examples of nontransitory storage devices include hard disk drives (HDDs), solid state drives (SSDs), universal serial bus (USB) flash drives, optical discs, and memory cards. These devices can store data long-term, ensuring that information is preserved and can be accessed even after the device is powered off. In some embodiments, a non-transitory storage device can include a database.

As used herein, the term “home brewed” access system can mean remote access with servers having a custom-built or do-it yourself (DIY) solution allowing devices to communicate with servers. This can include a variety of setups, such as home bridge, home servers and amateur radio systems.

As used herein, the term “content server” can also be referred to as a “hub” or an “elections compliance engine”, which may be abbreviated “ECE” and can function to configured to receive information, convert information, store information, compare information, automatically generate a remedial message, and/or transmit the remedial message. In some embodiments, the content server can accommodate any digital record created by the voter or the election office that is not exempt. Furthermore, digital copies of physical records can be stored, such as a digital copy of the signature on a physical mail ballot envelope. As used herein, the term “compliance rule” can mean a piece of code, algorithm or AI trained model that is precompiled and is built based on legal framework record for a jurisdiction. The rule can be defined by analysis of, e.g., legislation, coded by system engineers, and subject to quality assurance.

As used herein, the term “structured query language” can be abbreviated “SQL”, the term comma-separated values can be abbreviated “CSV”, the term “extensible markup language” can be abbreviated “XML”, the term “application programming interfaces” can be abbreviated “API”, the term “representational state transfer API” can be abbreviated “REST API”, the term “file transfer protocol” can be abbreviated “FTP”, the term “JavaScript Object Model” can be abbreviated “JSOM”, and the term “artificial intelligence” may be abbreviated “AI”.

As used herein, the term “electronic poll books” can be abbreviated as “E-poll books” or “EPBs”. Generally, E-poll books can replace traditional paper poll books and typically come in the form of laptops, tablets, or kiosks. The term “poll books” refers both to paper poll books and E-poll books.

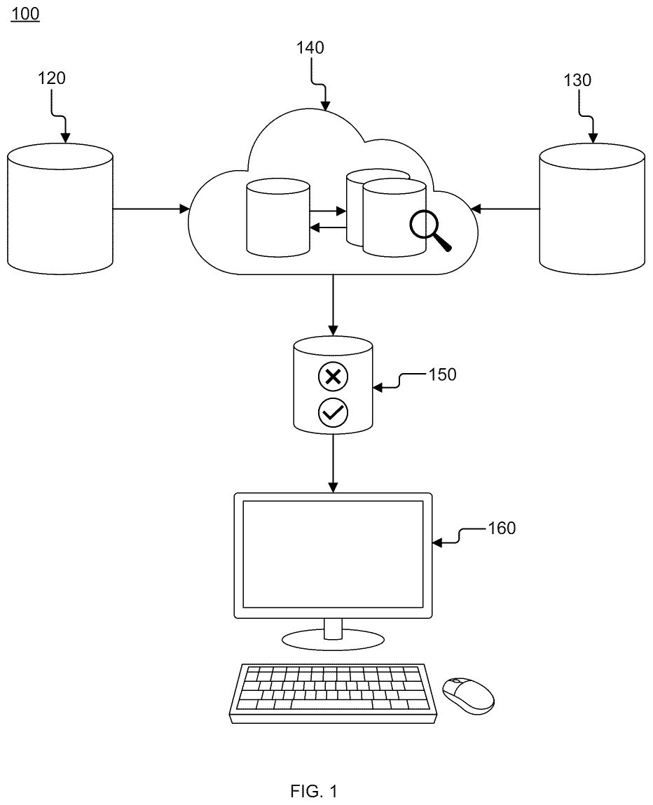

Referring now to FIG. 1, an exemplary election compliance assessment system 100, according to some embodiments of the present disclosure, is illustrated. In some aspects, the election compliance assessment system 100 may comprise at least one computing device 160, one or more databases 120, 130, 150, and one or more servers 140. In some implementations, the computing device 160, the databases 120, 130, 150, and the servers 140 may be communicatively coupled via at least one network connection, such as, for example and not limitation, a connection to the global, public Internet or a local area network (“LAN”) connection, as non-limiting examples. In some non-limiting exemplary embodiments, the servers 140 may be configured to facilitate a virtual cloud computing environment.

In some implementations, the computing device 160 and one or more of the servers 140 may comprise one or more coded machine-readable instructions or algorithms configured to implement or facilitate one or more methods or processes. By way of example and not limitation, the coded instructions may facilitate user interaction with at least one website accessed via the computing device 160 or the coded instructions may comprise at least one software application that may be downloaded and at least temporarily stored within at least one storage medium within the computing device 160. In some embodiments, the computing device 160 may comprise one or more of: a desktop computing device, a laptop computing device, a tablet computing device, a smartphone, a computing server, a virtual machine, a smart watch, a smart television, or a gaming console, as non-limiting examples.

In some aspects, the computing device 160 may be configured to allow at least one user to access, interact with, or otherwise utilize the election compliance assessment system 100. In some implementations, a user may comprise an elected public official, an election administrator, an election systems auditor, or any other representative tasked with maintaining the integrity of at least one election in at least one jurisdiction, such as by maintaining one or more voter rolls or lists for at least one jurisdiction, or a user may comprise a member of the general public seeking to assess the accuracy with which one or more voter rolls or lists are being maintained, or whether a recent election was conducted in compliance with one or more local laws, as non-limiting examples.

In some non-limiting exemplary embodiments, different types of users of the election compliance assessment system 100 may comprise different levels of access permissions. In some aspects, one or more portions of the election compliance assessment system 100 may be configured to operate or be initiated in an autonomous manner, wherein the user may comprise an automated user. In some embodiments, one or more users of the election compliance assessment system 100 may comprise super users. In some implementations, a super user may be able to access, manipulate, utilize, or control every aspect of the election compliance assessment system 100, including the data used by or stored within the election compliance assessment system 100, upon submitting one or more sufficient login credentials or similar authentication measures. By way of example and not limitation, a successfully authenticated super user may be able to instruct the election compliance assessment system 100 to generate one or more desired reports or initiate one or more processes, as non-limiting examples.

In some embodiments, the election compliance assessment system 100 may assist one or more super users or similar users with performing one or more duties, responsibilities, or obligations. By way of example and not limitation, a super user may comprise an election official tasked with overseeing the accuracy and completeness of elections within an election jurisdiction. As a non-limiting illustrative example, Florida Statute 97.012 (3) gives the Secretary of State the power to actively seek out and collect the data and statistics necessary to knowledgeably scrutinize the effectiveness of election laws. In some implementations, the election compliance assessment system 100 may assist the Secretary of State of Florida with executing this task. In some non-limiting exemplary embodiments, the election compliance assessment system 100 may be used in any election jurisdiction to assist with adherence to any applicable law, rule, guideline, or regulation, including any city, county, state, or federal jurisdiction, as non-limiting examples.

In some aspects, one or more users of the election compliance assessment system 100 may comprise permissions-confined users. In some embodiments, a permissions-confined user may have limited access or authority associated with the use of one or more portions of the election compliance assessment system 100 and the data associated therewith upon submitting one or more sufficient login or similar authentication credentials. By way of example and not limitation, a permissions-confined user may be able to instruct the election compliance assessment system 100 to generate only a subset of all of the potential reports the election compliance assessment system 100 may be capable of generating. In some implementations, one or more users of the election compliance assessment system 100 may comprise read-only users. In some embodiments, a read-only user may be able to view or otherwise receive a limited subset of one or more previously generated or requested reports, summaries, results, or similar outputs from the election compliance assessment system 100. In some implementations, a read-only user may not be required to submit any login or authentication credentials due to the limited amount of data the read-only user may have permission to access. In some aspects, a read-only user may comprise a member of the general public. By way of example and not limitation, a read-only user may not be able to view specific voter registration data for one or more maladministered voters, but the read-only user may be able to view a general summary for an election jurisdiction that may indicate that 1,000 registered voters in the jurisdiction had untimely processing of their undeliverable mail, as a non-limiting example. In some aspects, utilization of read-only protocols can enable the election compliance assessment system efficient and faster operations, as well as satisfy data security requirements.

In some aspects, the computing device 160 may be configured to use at least one network connection to communicate or exchange data with the servers 140. In some implementations, the servers 140 may be configured to communicate or exchange data with one or more databases 120, 130, 150, such as, for example and not limitation, submitting data requests or data to or retrieving data from the databases 120, 130, 150. In some aspects, the coded instructions of the servers 140 may be configured to identify data within two or more of the databases 120, 130 that may need to be correlated to perform at least one comparative analysis on the data to satisfy at least one user or automated process request received from at least one user or automated process via the computing device 160. By way of example and not limitation, the servers 140 may be configured to retrieve data from a first database 120 and a second database 130 and correlate the relevant data to respond to a request received from the computing device 160.

As a non-limiting illustrative example, a first database 120 may comprise voter registration data and a second database 130 may comprise transactional election data. In some aspects, a user comprising a member of the community of a jurisdiction in which an election was recently held may desire to assess a likelihood that the results of the election were counted in accordance with one or more local statutes. In some implementations, the user may use a computing device 160 to request a determination as to whether the voter rolls of the relevant jurisdiction are accurately maintained. In some embodiments, upon receiving the request, the servers 140 may retrieve voter registration data from the first database 120 and election data from the second database 130 and at least partially correlate the retrieved data to prepare the data for at least one comparative analysis. By way of example and not limitation, the servers may identify the voter identification number, as well as the status of each registered voter within the voter registration data and correlate such data with election data that may indicate the voter identification numbers of voters that submitted a ballot in a recent election.

In some aspects, the servers 140 may be configured to reference or otherwise utilize at least one datum comprising one or more parameters stored within a third database 150 to perform at least one comparative analysis on data retrieved from the first database 120 and/or the second database 130 to determine an assessment as to whether the data within the first database 120 and/or the second database 130 comprises any inaccuracies, omissions, or other errors that may indicate that the data is not in compliance with the parameters. By way of example and not limitation, the parameters within the third database 150 may comprise one or more rules, regulations, laws, guidelines, or opinions, such as, for further example and not limitation, those that may be related or applicable to execution of at least one election in at least one jurisdiction. In some implementations, the servers 140 may be configured to generate an alert or similar notification when one or more errors are detected, wherein the errors may be compiled and later presented with one or more relevant reports. In some non-limiting exemplary embodiments, the servers 140 may be configured to alert, then delay, then escalate for one or more detected errors to allow for errors to be resolved within a predetermined time span by election officials who are responsible for executing elections and overseeing the election systems, operations, and processes.

To further illustrate the previous example, in some implementations, the third database 150 may comprise one or more statutes that may indicate when a registered voter must be changed from an active status to an inactive status. By way of example and not limitation, a statute may indicate that upon a failure of a registered voter to respond to a final registration confirmation request within 30 days, the registered voter must be changed to an inactive status. In some aspects, such response failure data may be included within the voter registration data within the first database 120 such that when the servers 140 identify the relevant statute within the third database 150 and compare the voter registration data to the statute, the compliance assessment system 100 may determine that any registered voter that comprises the response failure should be set to an inactive status.

In some non-limiting exemplary implementations, the servers 140 may only need to reference the first database 120 when performing the comparative analysis with the parameters in the third database 150. By way of example and not limitation, a user may use the computing device 160 to submit a general inquiry, or at least one automated process may initiate at least one inquiry, for an assessment of whether data within the first database 120 satisfies the parameter data within the third database 150. As a non-limiting illustrative example, an election official may desire to assess whether the local voter roll is up to date and is accurate. In some aspects, the user may use the computing device 160 to query the servers 140 to retrieve voter registration data within the first database 120 and compare the data with one or more local statutes within the third database 150 to generate a determination or assessment as to whether the voter registration data is in compliance with the statutes. By way of example and not limitation, if a statute indicates that upon a failure of a registered voter to respond to a final registration confirmation request within 30 days, the registered voter must be changed to an inactive status, then the compliance assessment system 100 may determine that any registered voter that is associated with data that indicates such response failure should comprise an inactive status. In some embodiments, if any registered voter comprises an active status that is determined to comprise such response failure, the election compliance assessment system 100 may indicate that an error occurred.

In some aspects, the election compliance assessment system 100 may be configured to assess or determine whether elections held within a plurality of jurisdictions were conducted in accordance with one or more parameters that may be applicable to every jurisdiction within the plurality. As a non-limiting illustrative example, a state or federal law may mandate that different standards cannot be used to confirm the identity of voters participating within a state election. In some implementations, the servers 140 of the compliance assessment system 100 may retrieve election data from the second database 130 that includes signature verification data obtained or derived from a plurality of signature verification machines used in a plurality of counties or similar jurisdictions during a state election. In some embodiments, the signature verification data may include the minimum threshold similarity required to determine whether a signature submitted with a ballot matches a previously confirmed signature of a registered voter. By way of example and not limitation, a signature verification machine may be configured to determine that a match exists if the signatures are determined to be at least 80 percent similar. In some aspects, if the signature verification data indicates that different jurisdictions use different thresholds for assessing signature similarity, the election compliance assessment system 100 may indicate that an error has occurred.

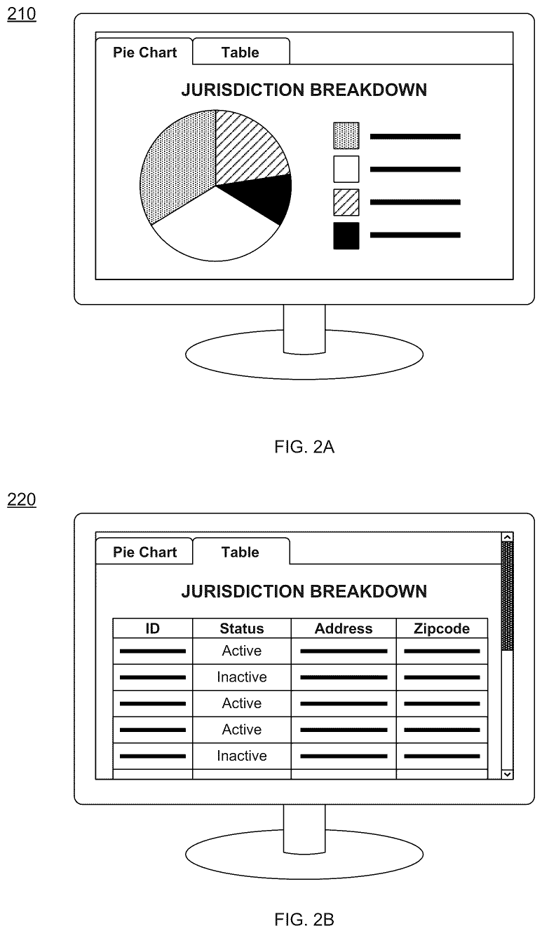

Referring now to FIGS. 2A and 2B, exemplary graphical user interfaces 210, 220 for an election compliance assessment system, according to some embodiments of the present disclosure, are illustrated. In some aspects, the election compliance assessment system may comprise at least one computing device communicatively coupled to one or more servers and one or more databases via at least one network connection to determine whether data within at least one of the databases satisfies one or more parameters.

In some implementations, the election compliance assessment system of the present disclosure may be configured to generate and present at least one graphical user interface (“GUI”) 210, 220 via at least one display mechanism, such as, for example and not limitation, a display screen, integrated with or communicatively coupled to the computing device. In some aspects, the GUI 210, 220 may be configured to display at least one structured format of one or more results determined by at least one comparative analysis performed by the election compliance assessment system. By way of example and not limitation, the structured format may comprise a report that may comprise one or more visual representations and/or text that may indicate an evaluative presentation of the results of the analysis. In some non-limiting exemplary embodiments, the GUI 210, 220 may be presented to at least one user comprising an election official or resident of a voting jurisdiction, as non-limiting examples.

In some implementations, the GUI 210 may be generated and presented by the election compliance assessment system to display at least one visual representation that may indicate how many data sets associated with voter registration data within at least one voting jurisdiction may be erroneous in at least one aspect. By way of example and not limitation, the visual representation may comprise one or more of: a pie chart, a bar graph, a line graph, a table, a numerical percentage, or text, as non-limiting examples. As a non-limiting illustrative example, the GUI 210 may generate and present a pie chart that may indicate a portion of the registered voters within a voting jurisdiction that are correctly identified as comprising an active status, a portion of the registered voters that comprise an incorrect active status, a portion of the voters that comprise an incorrect inactive status, or a portion of the registered voters that comprise some other error associated with their registration data, as non-limiting examples.

In some aspects, the GUI 220 may be generated and presented by the election compliance assessment system to display a visual representation that may indicate the status of each registered voter within a voting jurisdiction. By way of example and not limitation, the visual representation may comprise a table, chart, or similar information format that may list all of the registered voters within the voting jurisdiction as well as their status and other demographic information. In some implementations wherein the GUI 220 may present demographic information for each voter, the GUI may only be presented to election officials who may have previously registered an access account with the compliance assessment system so that such election officials may be able to login or otherwise be authenticated to assess the accuracy of the voter rolls or lists they are tasked with maintaining while maintaining the privacy of the registered voters by prohibiting access to one or more types of nonexempt election information by the general public.

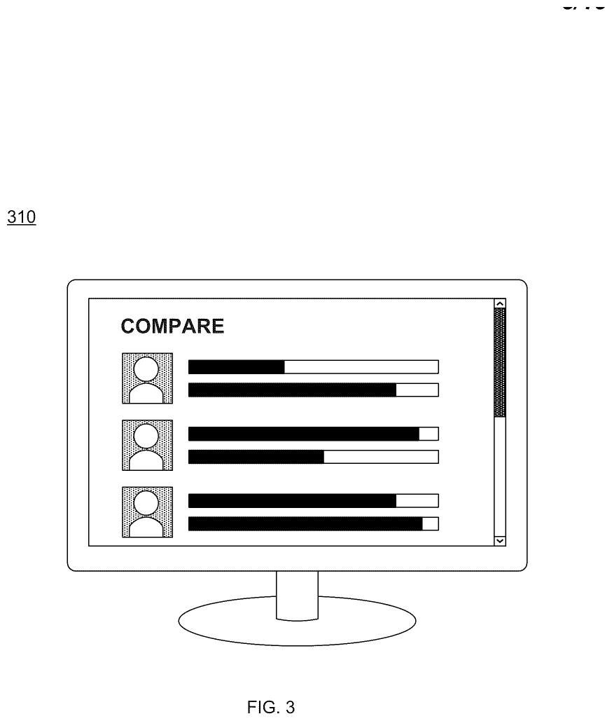

Referring now to FIG. 3, an exemplary graphical user interface 310 for an election compliance assessment system, according to some embodiments of the present disclosure, is illustrated. In some aspects, the election compliance assessment system may comprise at least one computing device communicatively coupled to one or more servers and one or more databases via at least one network connection to determine whether data within at least one of the databases satisfies one or more parameters.

In some implementations, the election compliance assessment system of the present disclosure may be configured to generate and present at least one graphical user interface (“GUI”) 310 via at least one display mechanism, such as, for example and not limitation, a display screen, integrated with or communicatively coupled to the computing device. In some aspects, the GUI 310 may be configured to display at least one structured format of one or more results determined by at least one comparative analysis performed by the compliance assessment system. By way of example and not limitation, the structured format may comprise a report that may comprise one or more visual representations and/or text that may indicate an evaluative presentation of the results of the analysis. In some non-limiting exemplary embodiments, the GUI 310 may be presented to at least one user comprising an election official or resident of a voting jurisdiction, as non-limiting examples.

In some aspects, the GUI 310 may be configured to present a comparison of one or more election compliance assessment results for a plurality of voting jurisdictions, as well as an indication of the election official tasked with maintaining election compliance in each of the relevant jurisdictions. By way of example and not limitation, the GUI 310 may be configured to present a list of jurisdiction election officials, as well as one or more indications of at least one compliance assessment of the voting jurisdiction associated therewith. As a non-limiting illustrative example, each election official may be presented with a visual representation of a portion of the voter registration data for the associated jurisdiction that is determined to be in compliance with local rules, regulations, laws, or other parameters, as well a portion of voter registration data and/or election data that is determined to be erroneous in at least one aspect, as non-limiting examples.

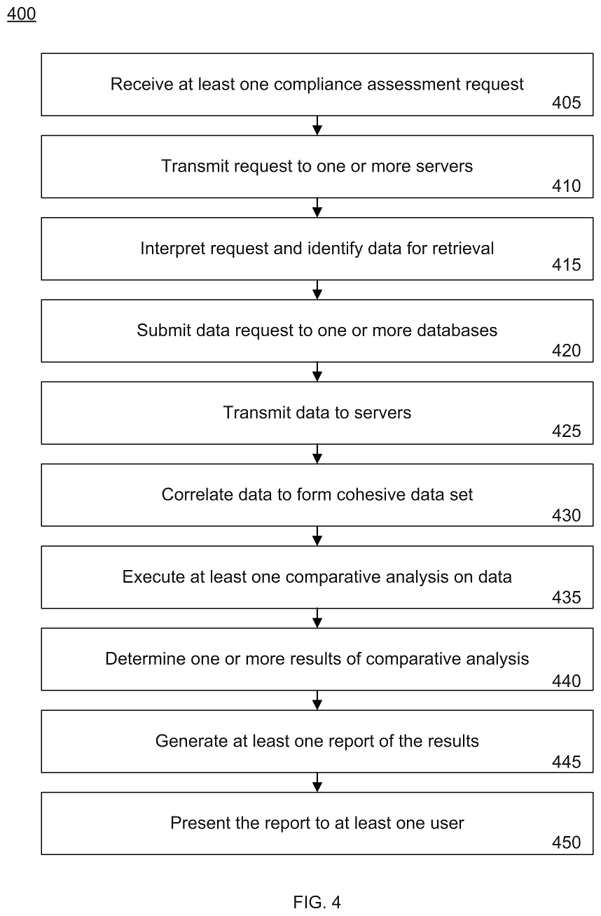

Referring now to FIG. 4, method steps for an exemplary process 400 for assessing election compliance, according to some embodiments of the present disclosure, are illustrated. In some implementations, process 400 may be at least partially implemented via an election compliance assessment system.

In some aspects, at 405, at least one election compliance assessment request may be received from at least one user. By way of example and not limitation, the user may comprise an automated user or a super user, such as, for example and not limitation, an elected official tasked with maintaining one or more voter rolls or lists for at least one voting jurisdiction, as non-limiting examples. In some embodiments, the election compliance assessment request may be received via at least one input device integrated with or communicatively coupled to at least one computing device, wherein the input device may comprise, by way of example and not limitation, one or more of: a keyboard, a pointing device, a touchscreen, a microphone, a camera, an accelerometer, or a motion detector, as non-limiting examples. In some implementations, at 410, the election compliance assessment request may be transmitted to and received by one or more servers. In some embodiments, at 415, the servers may interpret the request and identify one or more types of data that may need to be retrieved from one or more databases to satisfy the request. As a non-limiting illustrative example, if the request comprises an assessment of whether every ballot submitted during a recent election was received from an eligible voter, the servers may determine that data needs to be retrieved from at least one election system database, such as a voter registration database or an election database, as non-limiting examples.

In some aspects, at 420, the servers may submit a request to each relevant database for data needed to satisfy the user request. In some implementations, at 425, upon receiving the request from the servers, the database(s) may transmit the relevant data to the servers. In some embodiments, at 430, the servers may correlate the data from each database to form a cohesive data set. By way of example and not limitation, if voter registration data is received from a first database and election data is received from a second database, the servers may correlate the voter registration data with the election data to prepare the data for subsequent analysis or processing.

In some implementations, at 435, the servers may execute at least one comparative analysis on the retrieved data, wherein the retrieved data may be compared to one or more parameters, such as, for example and not limitation, one or more rules, regulations, laws, guidelines, opinions, or similar metrics. In some aspects, at 440, one or more results may be determined based on the comparative analysis, wherein the results may at least partially comprise an assessment of whether the retrieved data is in compliance with the referenced parameters. In some embodiments, at 445, the servers may generate a structured format, such as, for example and not limitation, a report, for communicating the results, wherein the report may comprise at least one visual representation and/or text. In some implementations, at 450, the report may be presented to the user that submitted the initial request, wherein the report may be presented, for example and not limitation, via a graphical user interface displayed upon a display screen integrated with or communicatively coupled to the computing device.

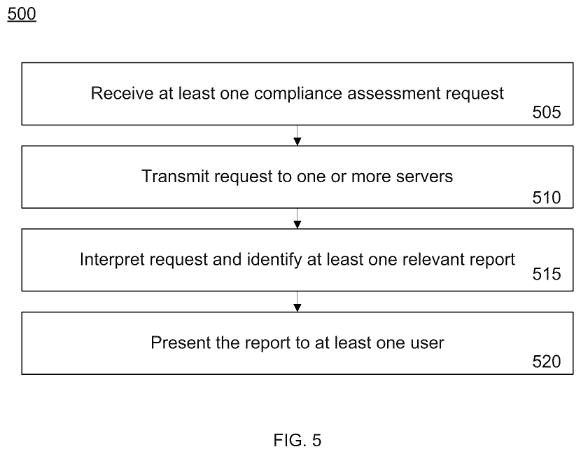

Referring now to FIG. 5, method steps for an exemplary process 500 for assessing election compliance, according to some embodiments of the present disclosure, are illustrated. In some implementations, process 500 may be at least partially implemented via an election compliance assessment system.

In some aspects, at 505, at least one election compliance assessment request may be received from at least one user. By way of example and not limitation, the user may comprise an automated user or a super user, such as, for example and not limitation, an elected official tasked with maintaining one or more voter rolls or lists for at least one voting jurisdiction, as non-limiting examples. In some embodiments, the election compliance assessment request may be received via at least one input device integrated with or communicatively coupled to at least one computing device, wherein the input device may comprise, by way of example and not limitation, one or more of: a keyboard, a pointing device, a touchscreen, a microphone, and a motion detector, as non-limiting examples.

In some implementations, at 510, the election compliance assessment request may be transmitted to and received by received by one or more servers. In some embodiments, at 515, the servers may interpret the request and identify at least one previously generated report that may be relevant to satisfy the request, wherein the report may be stored within at least one storage medium integrated with or communicatively coupled to at least one of the servers.

In some implementations, at 520, the report may be presented to the user that submitted the initial request, wherein the report may be presented, for example and not limitation, via a graphical user interface displayed upon a display screen integrated with or communicatively coupled to the computing device.

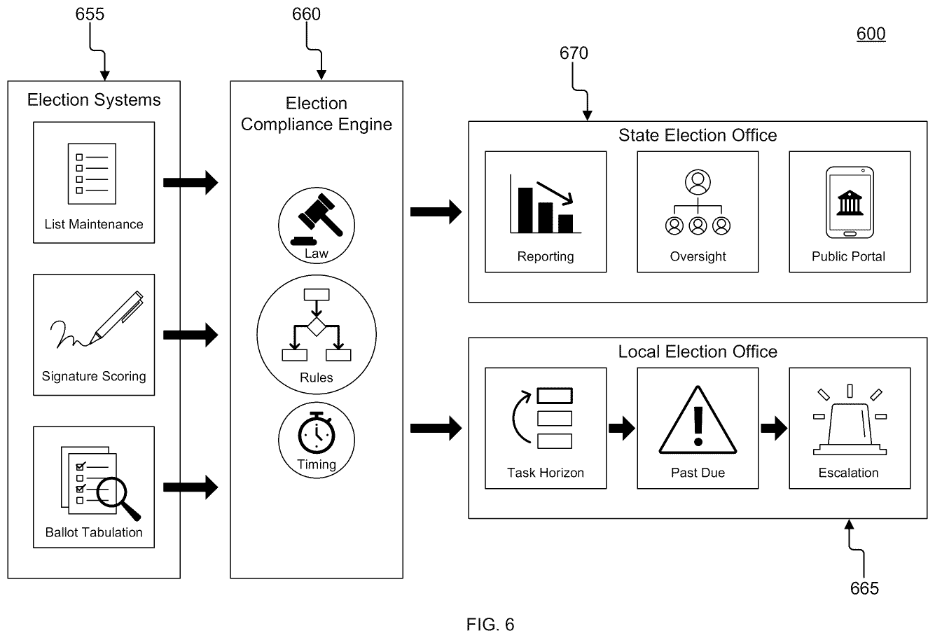

Referring now to FIG. 6, a flowchart depicting data flow through an election compliance assessment system 600, according to some embodiments of the present disclosure, is illustrated.

In some aspects, one or more election systems 655 may be communicatively coupled to an election compliance engine 660. In some implementations, each election system 655 may generate and at least temporarily store data that may be transmitted to and received by the election compliance engine 660, wherein the election compliance engine 660 may be configured to execute one or more analytical processes or functions on the received data. By way of example and not limitation, each election system 655 may comprise one of more of: a voter roll or voter list database, one or more signature verification machines, or one or more vote tabulator apparatus, wherein each election system 655 may be configured to output or log data or transactions as part of its normal operational functionality. In some embodiments, each election system 655 communicatively coupled to the election compliance engine 660 may be tracked, monitored, or otherwise routinely or continuously assessed by the election compliance engine 660 in an at least partially autonomous manner.

As a non-limiting illustrative example, at least one election system 655 may comprise a voter list maintenance system configured to generate at least one audit log to record changes made to a voter list or voter roll associated with an election jurisdiction. In some implementations, the election compliance engine 660 may be configured to retrieve voter roll data from the voter roll list and analyze the data by comparing the data to one or more federal, state, or local laws, rules, time requirements, or similar parameters that may allow the election compliance engine 660 to determine whether the voter roll list is accurate and up-to-date.

As an additional non-limiting example, one or more signature verification machines configured as part of an election system 655 may be configured to compare signatures on ballots cast during an election against stored signatures of registered voters. In some implementations, each signature verification machine may be configured to assign a score to each signature, wherein the score level may indicate whether each signature should be accepted or rejected based on one or more statutes or similar laws. In some embodiments, the election compliance engine 660 may be configured to analyze data logged and stored by the signature verification machines to determine whether ballots associated with rejected signatures were counted in the relevant election.

By way of further example and not limitation, one or more vote tabulator apparatus may be configured as part of an election system 655. In some aspects, the election compliance engine 660 may be configured to retrieve configuration, usage, and performance data from each vote tabulator apparatus prior to and/or during an election such that the election compliance engine 660 may be able to determine whether the software executed by each vote tabulator apparatus was certified in accordance with any applicable laws or whether the software was functioning as certified and/or was configured in accordance with the certification, as non-limiting examples.

In some aspects, the election compliance engine 660 may be configured to generate one or more results or similar outputs and present the output data to one or more users. In some non-limiting exemplary implementations, the election compliance engine 660 may be configured to provide one or more outputs to one or more users at a local election office 665 for an election jurisdiction. In some embodiments, by using the election compliance engine 660, the local election officials may be able to conveniently and efficiently monitor and track tasks that need to be performed to maintain accurate and updated election systems 655 and voter registration data. By way of example and not limitation, the election compliance engine 660 may generate and present upcoming or “horizon” tasks that need to be executed within a certain timeframe in accordance with one or more laws.

As a non-limiting illustrative example, an election official may receive notice that a registered voter may have changed legal residences such that the voter may no longer reside in an election jurisdiction. An election law may require the election official to send the registered voter a notice inquiring about the voter's current legal residence and, if the election official does not receive a response from the voter, the election law may require that the voter's status be changed to an inactive status. However, if the timing of the required status change occurs less than 90 days before an upcoming election, a second law may indicate that the voter's status cannot be changed to inactive until after the election. Therefore, the status change may be identified and tracked as a pending task scheduled after the election.

In some implementations, the election compliance engine 660 may be configured to notify one or more local election officials when one or more tasks or actions are past due, thereby requiring a timely remedy. In some non-limiting exemplary embodiments, the election compliance engine 660 may be configured to allow for a predetermined amount of time, or “grace period,” for the notified officials to take remedial action. In some aspects, failure of the local official to take remedial action may cause the election compliance engine 660 to escalate the notification(s) to one or more users with increased authority or to the general public, as non-limiting examples.

In some aspects, the election compliance engine 660 may be configured to present one or more types of data to one or more oversight users, such as one or more users with increased authority or one or more members of the general public. By way of example and not limitation, the election compliance engine 660 may present data to one or more state or federal election officials at a federal or state office 670, who may have more authority than local election officials. In some embodiments, the election compliance engine 660 may generate one or more summary reports of data trends or statistics identified or determined by analyzing data received from the election systems 655. In some implementations, these reports may be used by authoritative users or members of the public to monitor the performance of local election officials. In some non-limiting illustrative examples, members of the public may access the reports or other data summaries via a public portal presented on a local or remote computing device.

In some embodiments, the election compliance engine 660 may be configured to perform one or more of a variety of assessments or analytical functions on data received from the election systems 655. By way of example and not limitation, the election compliance engine 660 may be able to detect one or more statistical anomalies in cast vote records, one or more errors in the aggregation of votes, one or more errors in the tracking and/or reconciliation of paper ballots and/or ballot images, one or more errors in the chain of custody of ballots and/or other election materials, one or more errors or inconsistencies pertaining to one or more demographics associated with one or more voter registration records, or one or more errors associated with the creation and/or management of one or more vote-by-mail records, as non-limiting examples.

In some non-limiting exemplary embodiments, the election compliance engine 660 may comprise one or more artificial intelligence or machine learning algorithms to supplement or assist in analyzing data received from the election systems 655, and/or to generate one or more data reports or other data summaries. In some aspects, the artificial intelligence algorithms may be trained to recognize any parameters, such as statutes or other laws, used by the election compliance engine 660 to enable the election compliance assessment system 600 to continuously improve its analytical capabilities, as well as routinely suggest the implementation of new methods of data analysis to the functionality of the election compliance assessment system 600.

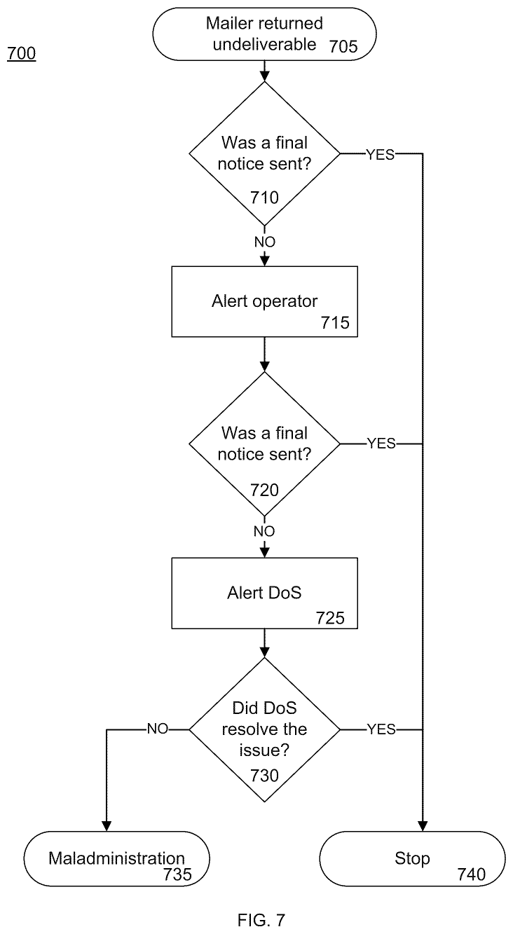

Referring now to FIG. 7, method steps for an exemplary process 700 for assessing election system compliance, according to some embodiments of the present disclosure, are illustrated. In some implementations, process 700 may be at least partially implemented via an election compliance assessment system communicatively coupled to at least one election system, wherein the election compliance assessment system may be configured to receive one or more types of data generated by the election system. In some embodiments, process 700 may be implemented to update one or more voter rolls or lists, or similar compilations of voter registration data, in accordance with one or more laws or rules.

As a non-limiting illustrative example, a statute associated with an election jurisdiction may require that if an address confirmation request is returned as undeliverable without indication of an address change, or there is no response from the voter after 30 days, or if any other non-forwardable return-if-undeliverable mail is returned as undeliverable with no indication of an address change, an election official shall send an address confirmation final notice to all addresses on file for the voter.

In some aspects, at 705, a mailer addressed to a registered voter within the election jurisdiction may be returned as undeliverable. In some implementations, at 710, the election compliance assessment system may determine whether a final address confirmation was sent to the registered voter. In some embodiments, the determination may be at least partially based on audit log data recorded by the election system(s). In some implementations, the determination may be configured to be made within a predetermined amount of time after the mailer was returned, such as, for example and not limitation, 30 days, or any amount of time that may be required by one or more statutes or other laws. In some aspects, an affirmative determination may cause process 700 to proceed to step 740, while a negative determination may cause process 700 to proceed to step 715.

In some implementations, at 715, the election compliance assessment system may generate and present at least one alert or similar notification to at least one operator or other user of the election compliance assessment system. In some aspects, the alert may prompt the user that a final notice needs to be sent. In some implementations, at 720, the election compliance assessment system may make a second determination as to whether a final notice was sent to the registered voter. In some non-limiting exemplary embodiments, the second determination may be configured to be made after a predetermined amount of time following the presentation of the alert notification. By way of example and not limitation, the determination may be configured to occur seven days after the alert was presented, thereby giving the user a chance to remedy the issue. In some implementations, an affirmative determination may cause process 700 to proceed to step 740, while a negative determination may cause process 700 to proceed to step 725.

In some aspects, at 725, an alert or similar notification may be generated and presented to at least one user with increased authority, such as, for example and not limitation, a Department of State head or official or similar manager of elections, as non-limiting examples. In some implementations, at 730, the election compliance assessment system may make a third determination as to whether the pending issue was resolved. In some non-limiting exemplary embodiments, the third determination may occur after a predetermined amount of time following the presentation of the alert to the Department of State, such as, for example and not limitation, seven days. In some implementations, the election compliance assessment system may be configured to iteratively determine whether the pending issue was resolved after various predetermined amounts of time such that the issue may be escalated to officials with increasingly higher authority levels for review and/or action.

In some aspects, an affirmative determination may cause process 700 to proceed to step 740 while a negative determination may cause process 700 to proceed to step 735.

In some implementations, at 735, the election compliance assessment system may determine that maladministration is occurring with regard to implementing or maintaining one or more election systems or processes or executing or conducting one or more elections within the election jurisdiction, while at 740, process 700 may conclude with an assessment that no remedial action is needed.

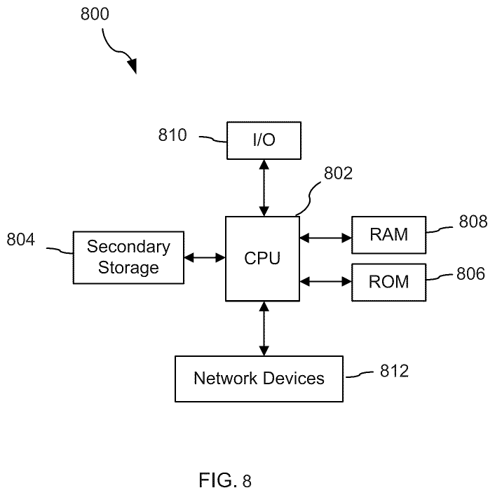

FIG. 8 illustrates a computer system 800 suitable for implementing one or more embodiments disclosed herein. The computer system 800 includes a processor 802 (which may be referred to as a central processor unit (CPU)) that is in communication with memory devices including secondary storage 804, read-only memory (ROM) 806, random-access memory (RAM) 808, input/output (I/O) devices 810, and network connectivity devices 812. The computer system 800 may be comprised in an election compliance assessment system, such as systems 100 or 660, disclosed herein. The processor 802 may be implemented as one or more CPU chips.

It is understood that by programming and/or loading executable instructions onto the computer system 800, at least one of the CPU 802, the RAM 808, and the ROM 806 are changed, transforming the computer system 800 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application-specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 800 is turned on or booted, the CPU 802 may execute a computer program or application. For example, the CPU 802 may execute software or firmware stored in the ROM 806 or stored in the RAM 808. In some cases, on boot and/or when the application is initiated, the CPU 802 may copy the application or portions of the application from the secondary storage 804 to the RAM 808 or to memory space within the CPU 802 itself, and the CPU 802 may then execute instructions that the application is comprised of. In some cases, the CPU 802 may copy the application or portions of the application from memory accessed via the network connectivity devices 812 or via the I/O devices 810 to the RAM 808 or to memory space within the CPU 802, and the CPU 802 may then execute instructions that the application is comprised of. During execution, an application may load instructions into the CPU 802, for example load some of the instructions of the application into a cache of the CPU 802. In some contexts, an application that is executed may be said to configure the CPU 802 to do something, e.g., to configure the CPU 802 to perform the function or functions promoted by the subject application. When the CPU 802 is configured in this way by the application, the CPU 802 becomes a specific purpose computer or a specific purpose machine.

The secondary storage 804 is typically comprised of one or more disk drives or tape drives and is used for non-volatile storage of data and as an over-flow data storage device if RAM 808 is not large enough to hold all working data. Secondary storage 804 may be used to store programs which are loaded into RAM 808 when such programs are selected for execution. The ROM 806 is used to store instructions and perhaps data which are read during program execution. ROM 806 is a non-volatile memory device which typically has a small memory capacity relative to the larger memory capacity of secondary storage 804. The RAM 808 is used to store volatile data and perhaps to store instructions. Access to both ROM 806 and RAM 808 is typically faster than to secondary storage 804. The secondary storage 804, the RAM 808, and/or the ROM 806 may be referred to in some contexts as computer readable storage media and/or non-transitory computer readable media.

I/O devices 810 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 812 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 812 may provide wired communication links and/or wireless communication links (e.g., a first network connectivity device 812 may provide a wired communication link and a second network connectivity device 812 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WIFI (IEEE 802.11), Bluetooth, ZIGBEE, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 812 may enable the processor 802 to communicate with the Internet or one or more intranets. With such a network connection, it is contemplated that the processor 802 might receive information from the network, or might output information to the network in the course of performing the above-described method steps. Such information, which is often represented as a sequence of instructions to be executed using processor 802, may be received from and outputted to the network, for example, in the form of a computer data signal embodied in a carrier wave.

Such information, which may include data or instructions to be executed using processor 802 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 802 executes instructions, codes, computer programs, scripts which it accesses from hard disk, floppy disk, optical disk (these various disk based systems may all be considered secondary storage 804), flash drive, ROM 806, RAM 808, or the network connectivity devices 812. While only one processor 802 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 804, for example, hard drives, floppy disks, optical disks, and/or other device, the ROM 806, and/or the RAM 808 may be referred to in some contexts as non-transitory instructions and/or non-transitory information.

In an embodiment, the computer system 800 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 800 to provide the functionality of a number of servers that is not directly bound to the number of computers in the computer system 800. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer-usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 800, at least portions of the contents of the computer program product to the secondary storage 804, to the ROM 806, to the RAM 808, and/or to other non-volatile memory and volatile memory of the computer system 800. The processor 802 may process the executable instructions and/or data structures in part by directly accessing the computer program product, for example by reading from a CD-ROM disk inserted into a disk drive peripheral of the computer system 800. Alternatively, the processor 802 may process the executable instructions and/or data structures by remotely accessing the computer program product, for example by downloading the executable instructions and/or data structures from a remote server through the network connectivity devices 812. The computer program product may comprise instructions that promote the loading and/or copying of data, data structures, files, and/or executable instructions to the secondary storage 804, to the ROM 806, to the RAM 808, and/or to other non-volatile memory and volatile memory of the computer system 800.

In some contexts, the secondary storage 804, the ROM 806, and the RAM 808 may be referred to as a non-transitory computer readable medium or a computer readable storage media. A dynamic RAM embodiment of the RAM 808, likewise, may be referred to as a non-transitory computer readable medium in that while the dynamic RAM receives electrical power and is operated in accordance with its design, for example during a period of time during which the computer system 800 is turned on and operational, the dynamic RAM stores information that is written to it. Similarly, the processor 802 may comprise an internal RAM, an internal ROM, a cache memory, and/or other internal non-transitory storage blocks, sections, or components that may be referred to in some contexts as non-transitory computer readable media or computer readable storage media.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “service,” “module,” and “component” as used herein generally represent software, firmware, hardware, or any combination thereof. In the case of a software implementation, the service, module, or component represents program code that performs specified tasks when executed on one or more processors. The program code may be stored in one or more computer readable memory devices. The features of the present disclosure described herein are platform-independent, meaning that the techniques can be implemented on a variety of commercial computing platforms having a variety of processors (e.g., desktop, laptop, notebook, tablet computer, personal digital assistant (PDA), mobile telephone, smart telephone, gaming console, and the like).

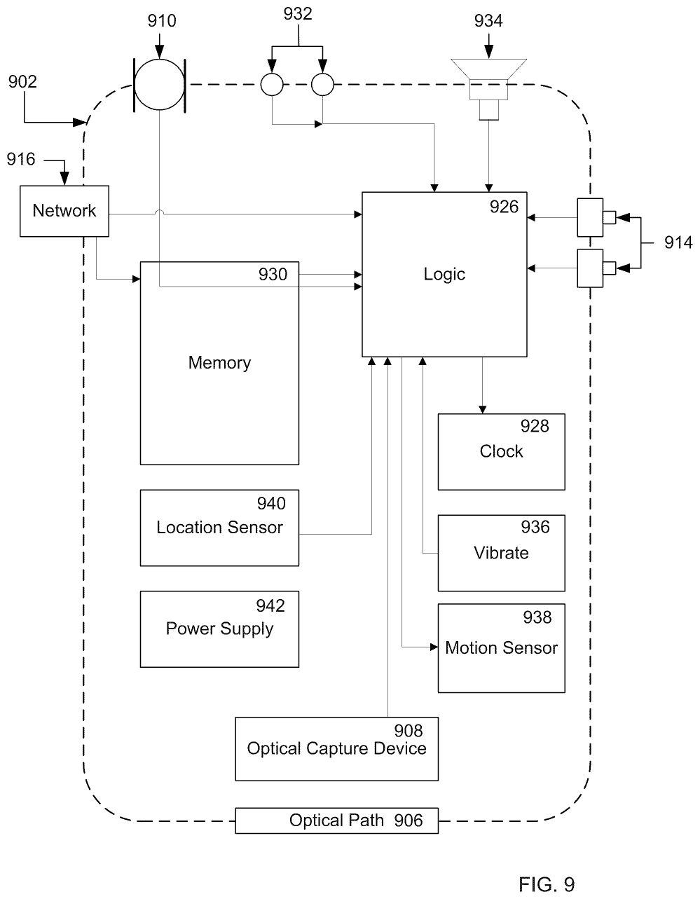

Referring now to FIG. 9, a block diagram of an exemplary embodiment of another computing device 902 that may be utilized within an election compliance assessment system, according to some embodiments of the present disclosure, is illustrated.

In some aspects, the computing device 902 may comprise an optical capture device 908, which may capture an image and convert it to machine-compatible data, and an optical path 906, typically a lens, an aperture, or an image conduit to convey the image from a rendered document to the optical capture device 908. The optical capture device 908 may incorporate a Charge-Coupled Device (CCD), a Complementary Metal Oxide Semiconductor (CMOS) imaging device, or an optical sensor of another type.

In some embodiments, the computing device 902 may comprise a microphone 910, wherein the microphone 910 and associated circuitry may convert the sound of the environment, including spoken words, into machine-compatible signals. Input facilities 914 may exist in the form of buttons, scroll-wheels, or other tactile sensors such as touchpads. In some embodiments, input facilities 914 may include a touchscreen display. Visual feedback 932 to the user may occur through a visual display, touchscreen display, or indicator lights. Audible feedback 934 may be transmitted through a loudspeaker or other audio transducer. Tactile feedback may be provided through a vibration module 936.

In some aspects, the computing device 902 may comprise a motion sensor 938, wherein the motion sensor 938 and associated circuitry may convert the motion of the computing device 902 into machine-compatible signals. For example, the motion sensor 938 may comprise an accelerometer, which may be used to sense measurable physical acceleration, orientation, vibration, and other movements. In some embodiments, the motion sensor 938 may comprise a gyroscope or other device to sense different motions.

In some implementations, the computing device 902 may comprise a location sensor 940, wherein the location sensor 940 and associated circuitry may be used to determine the location of the device 902. The location sensor 940 may detect Global Position System (GPS) radio signals from satellites or may also use assisted GPS where the computing device 902 may use a cellular network to decrease the time necessary to determine location. In some embodiments, the location sensor 940 may use radio waves to determine the distance from known radio sources such as cellular towers to determine the location of the computing device 902. In some embodiments these radio signals may be used in addition to and/or in conjunction with GPS.

In some aspects, the computing device 902 may comprise a logic module 926, which may place the components of the computing device 902 into electrical and logical communication. The electrical and logical communication may allow the components to interact. Accordingly, in some embodiments, the received signals from the components may be processed into different formats and/or interpretations to allow for the logical communication.

The logic module 926 may be operable to read and write data and program instructions stored in associated storage 930, such as RAM, ROM, flash, or other suitable memory. In some aspects, the logic module 926 may read a time signal from the clock unit 928. In some embodiments, the computing device 902 may comprise an on-board power supply 942. In some embodiments, the computing device 902 may be powered from a tethered connection to another device, such as a Universal Serial Bus (USB) connection.

In some implementations, the computing device 902 may comprise a network interface 916, which may allow the computing device 902 to communicate and/or receive data to a network and/or an associated computing device. The network interface 916 may provide two-way data communication.

For example, the network interface 916 may operate according to an internet protocol. As another example, the network interface 916 may comprise a local area network (“LAN”) card, which may allow a data communication connection to a compatible LAN. As another example, the network interface 916 may comprise a cellular antenna and associated circuitry, which may allow the computing device 902 to communicate over standard wireless data communication networks. In some implementations, the network interface 916 may comprise a Universal Serial Bus (USB) to supply power or transmit data. In some embodiments, other wireless links known to those skilled in the art may also be implemented.

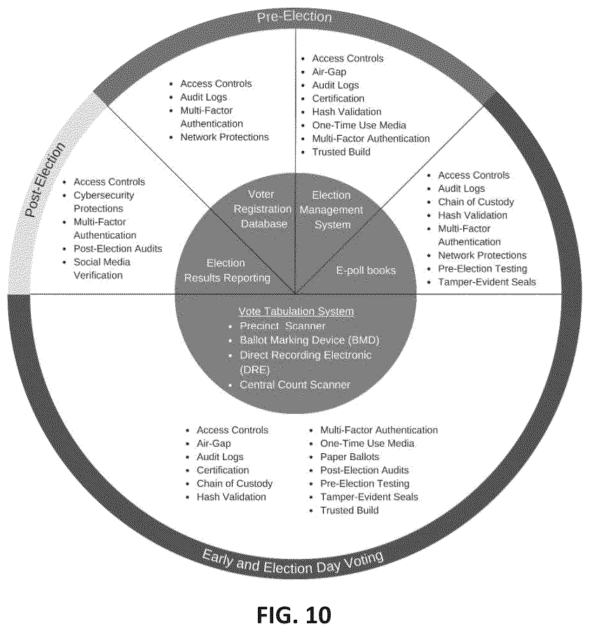

FIG. 10 depicts a diagram of abstract depiction of generally preferred practices in some embodiments during pre-election, early and election voting, e.g., during the election, and post-election. Generally, access to voter registration databases requires remote access provided by encryption and authorized and/or authenticated access via an API to satisfy election laws for cybersecurity, as well as Department of Homeland Security (DHS) rules, Secure Information Sharing Architecture (SISA) rules, National Institute of Standards and Technology (NIST) guidelines, federal requirements for election systems, and other compliance requirements. As an example, pre-election safeguards for a voter registration database and an election management system can include access controls, audit logs, multi-factor authentication, network protections, air-gaps, certification, hash validation, one-time use media, and trusted build. During the election, safeguards for E-poll books and a vote tabulation system including a precinct scanner, a ballot marking device (BMD), a direct recording electronic (DRE), and a central count scanner, can include access controls, audit logs, multi-factor authentication, hash validation, recordation of chain of custody, network protections, pre-election testing, tamper-evident seals, one-time use media, air-gaps, certification, hash validation, paper ballots, post-election audits, and trusted build. Post-election safeguards can include access controls, cybersecurity protections, multi-factor authentication, post-election audits, and social media verification.

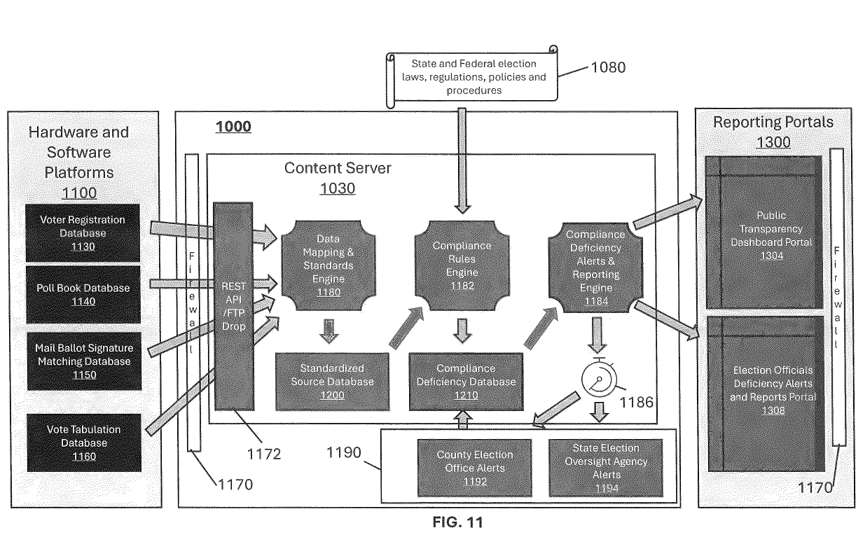

Referring to FIG. 11, an election system 1000 for maintaining election integrity in at least one jurisdiction is depicted in some embodiments. Generally, the election system 1000 is a stand-alone arrangement to prevent changes in the information stored at the hardware and software platforms 1100 provided to the content server 1030. The election system 1000 can include at least one firewall 1170, a REST API and/or a FTP drop 1172, and a content server 1030. The content server 1030 can include a data mapping and standards engine 1180, a compliance rules engine 1182, a compliance deficiency alerts and reporting engine 1184, a standardized source database 1200, and a compliance deficiency database 1210. The content server 1030 can be in communication with hardware and software platforms 1100 and reporting portals 1300. Although the reporting portals 1300 are outside the election system 1000 in the depicted embodiment, in some embodiments, the reporting portals 1300 can be comprised in the election system 1000 and can include a public transparency dashboard portal 1304 and an election officials deficiency alerts and reports portal 1308. The election system 1000 can further include a timer 1186. The hardware and software platforms 1100 can include a voter registration database 1130, a poll book database 1140, a mail ballot signature matching database 1150, and/or a vote tabulation database 1160, which in some embodiments one or more of these databases 1130, 1140, 1150, and/or 1160 may be referred to as an election data source database. As an example, the vote tabulation database 1160 can indicate the name of the voter voting in a jurisdiction, and after an election, the name can be crossed against the voter registration database 1130 to confirm that the person voted is eligible for future elections.

In operation, information from one or more of the databases 1130, 1140, 1150, and 1160 can be retrieved via a REST API and/or a FTP drop 1172 through the firewall 1170. Generally, the information is obtained in a non-standardized format. In some embodiments, the data from databases 1130, 1140, 1150, and 1160 can be in a different format for each database 1130, 1140, 1150, or 1160, i.e., each database 1130, 1140, 1150, or 1160 can have their data in a format, e.g., CSV, XML, etc., different as compared to the other databases 1130, 1140, 1150, or 1160. Once the AI model is developed, data pulled from each database 1130, 1140, 1150, and 1160 in different formats can be converted and stored in a standardized format for comparison in the compliance rules engine 1182. In this standardized format, in an example, data comprised of millions of individual voters registration data can be transferred to the content server 1030, converted, and stored as standardized data in real time, such as on an hourly basis.

The information can be subject to the data mapping and standards engine 1180 to convert information into a standardized format for saving in a standardized source database 1200. What is more, one or more legal framework records 1080 can be obtained and entered in a standardized format into a compliance rules engine 1182.

The one or more legal framework records 1080 are the applicable law, rules, opinions and guidelines that a particular jurisdiction is required to follow for conducting an election. If the jurisdiction is a state, such as Texas, the laws and/or regulations of Texas would be included, but typically not the laws and/or regulations of another state, such as Arkansas, but applicable federal laws and regulations may be included. The legal framework records 1080 are converted into compliance rules at the engine 1182 for that jurisdiction.

In some embodiments, a legislative analyst can examine the legal framework records 1080, e.g., laws and regulations, for a particular jurisdiction for conducting an election. The legislative analyst can extract the relevant rules pertaining to an election in that jurisdiction, including voter requirements, election day procedures, signature requirements, tabulation procedures, etc., and with a programmer, prepare compliance rules in a standardized format for saving in the compliance rules engine 1182. After creating the compliance rules for the engine 1182, the legislative analyst can provide updates on the changes in law of that jurisdiction for updating the compliance rules with the assistance of a programmer for the engine 1182.

In some embodiments, an AI developed model can be used to retrieve the relevant legal framework records 1080. Generally, retrieving the legal framework records 1080 can be from one or several databases in a non-standardized format. A data mapping and standards engine, such as the engine 1180 or another engine with similar functionality, can be applied to the non-standardized format to convert the rules into a standardized format for storing compliance rules in the compliance rules engine 1182. These standardized compliance rules stored in the compliance rules engine 1182 can be utilized for making comparisons with standardized data from the standardized source database 1200.

In some embodiments, the compliance rules engine 1182 can store a library of compliance rules for conducting an election in the jurisdiction. As an example, some of the rules may be applicable for determining a qualified registered voter from data retrieved from the voter registration database 1130, while other rules may be applicable to auditing data from the poll book database 1140. An AI developed model can be utilized to select rules from the compliance rules library for conducting the proper analysis based on the standardized data being retrieved from the standardized source database 1200.

The standardized information in the database 1200 is provided to the compliance rules processing engine 1182 for comparison with the compliance rules. The comparison can identify deficiencies that can be stored in the compliance deficiency database 1210. The comparison can utilize any suitably trained AI module for identifying deficiencies in the information obtained from the hardware and software platforms 1100. These deficiencies can include voters that have moved from the jurisdiction, deceased, or otherwise not qualified to vote in the election.

These deficiencies can be uploaded to the compliance deficiency alerts and reporting engine 1184, which can provide notice to one or more alerts 1190, such as the county election office alerts 1192, the state election oversight agency alerts 1194, or a combination thereof. The alerts 1192 and 1194 can notify the relevant election personnel of deficiencies within the election system 1000 that are subject to corrective action. The timer 1186 can measure a predetermined amount of time for second notice should election personnel be unresponsive to the first notice. Once corrective action has been undertaken, the deficiency can be recorded as corrected in the compliance deficiency database 1210.

The compliance deficiency alerts and reporting engine 1184 can also communicate with the reporting portals 1300. The reporting portals 1300 can include the public transparency dashboard portal 1304 and the election officials deficiency alerts and reports portal 1308. The public transparency dashboard portal 1304 can allow members of the public to view and alert elected officials of deficiencies in the election system 1000. The election officials deficiency alerts and reports portal 1308 allows election officials, including those elected to office and optionally in a supervisory position, to view deficiencies in the system and whether corrective action has been undertaken by election personnel. The election system 1000 can process thousands or millions of records in real-time allowing immediate auditing of elections conducted in the jurisdiction and notifications of deficiencies requiring correction.

In some embodiments, the data retrieved from the hardware and software platforms 1100, e.g., the voter registration database 1130, can be encrypted to protect voter data. As an example, at the data mapping and standards engine 1180, the data can be unencrypted for standardizing. After standardization, in some embodiments, the data can be re-encrypted while saved in the standardized source database 1200 and unencrypted for comparing in the compliance rules engine 1182.

In some embodiments, data can be encrypted when outputted. An AI developed model can determine which outputted data is encrypted. As an example, if an alert is provided to one or more alerts 1190, such an alert may be encrypted depending on the content. As an example, if it is determined that a threshold of errors, such as at least about 1% of errors, are required to remove unqualified voters, such an alert can be transmitted unencrypted. However, if the alert is sent to remove individual voters, and their data, from the voter rolls, such an alert of personalized individual data can be determined to require encryption by the AI model, and such information can be encrypted for security purposes.

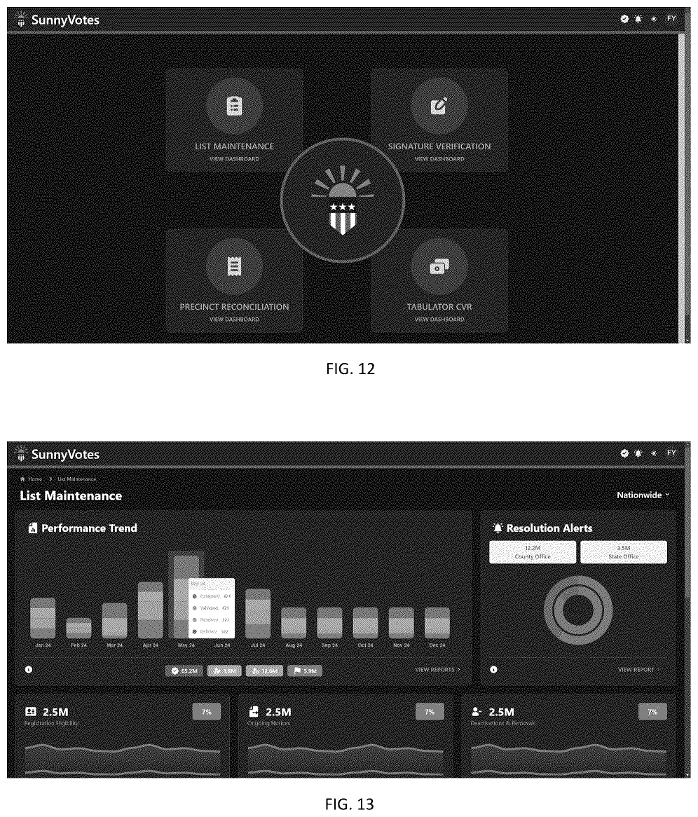

Referring to FIGS. 12-17, various graphical user interfaces for one or more users are depicted for operating the election system 1000 in some embodiments for the reporting portals 1300. As depicted in FIG. 12, the main landing page of the election system 1000 can provide a centralized access point to key election management modules. Authorized users can navigate to different functional dashboards, including list maintenance, signature verification, precinct reconciliation, and tabulator cast vote record (CVR). Each section supports election officials in efficiently managing various aspects of the election process, from maintaining voter lists to verifying signatures and reconciling precinct data, thereby providing efficient, intuitive access to critical tools for maintaining election integrity. The main landing page can be accessed via the public transparency dashboard portal 1304 and/or the election officials deficiency alerts and reports portal 1308, in some embodiments.

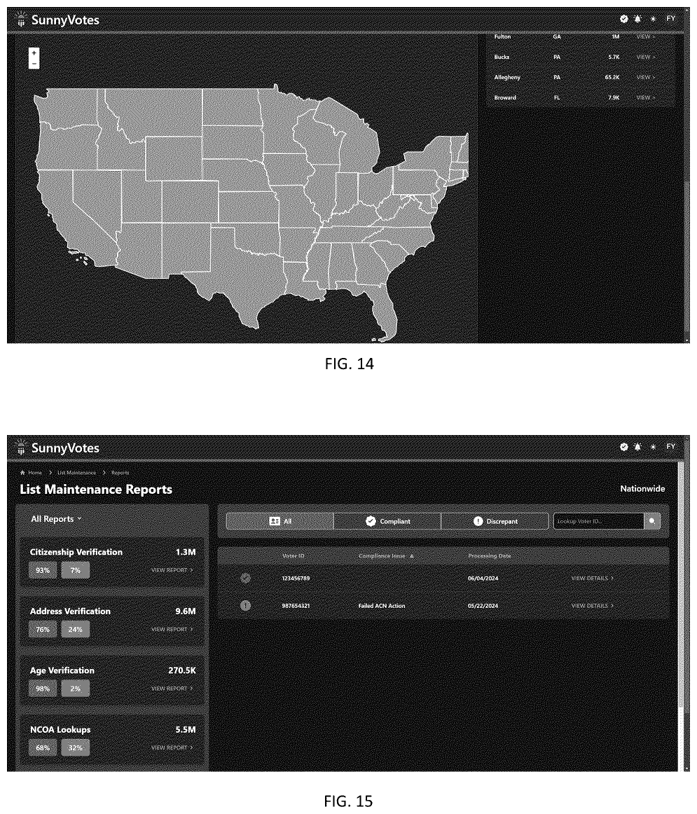

As depicted in FIGS. 13 and 14, a partial dashboard for accessing various functions is depicted. This software interface is designed for comprehensive election list maintenance and performance tracking, and visually represents key metrics such as compliance, validation, resolution statuses, and deficiencies over time, allowing election officials to monitor and maintain voter registration data. The dashboard includes alerts for necessary actions, total numbers of pending registrations, ongoing notices, and deactivations to ensure election processes operate efficiently across different offices. As depicted in FIG. 14, another part of the dashboard can be an interactive map allowing for federal, state, and county oversight of data. The side panel lists user-selected metrics such as the number of registered voters, enabling election officials access to navigate to areas of interest for detailed review. A public portal can provide read-only access to inspect non-exempt election activities, thereby providing transparency through oversight. The dashboard can be accessed via the public transparency dashboard portal 1304 and/or the election officials deficiency alerts and reports portal 1308, in some embodiments.

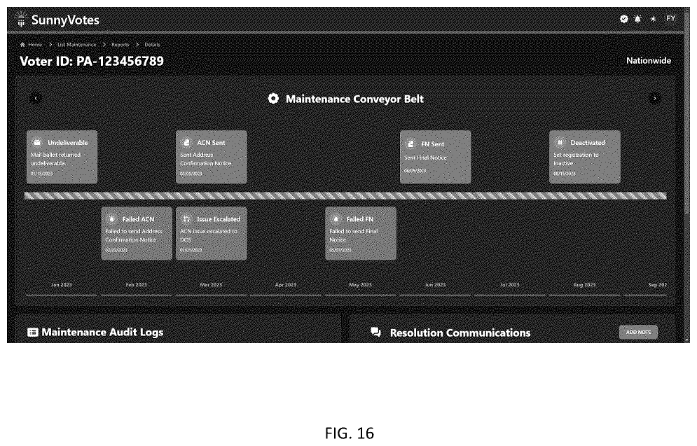

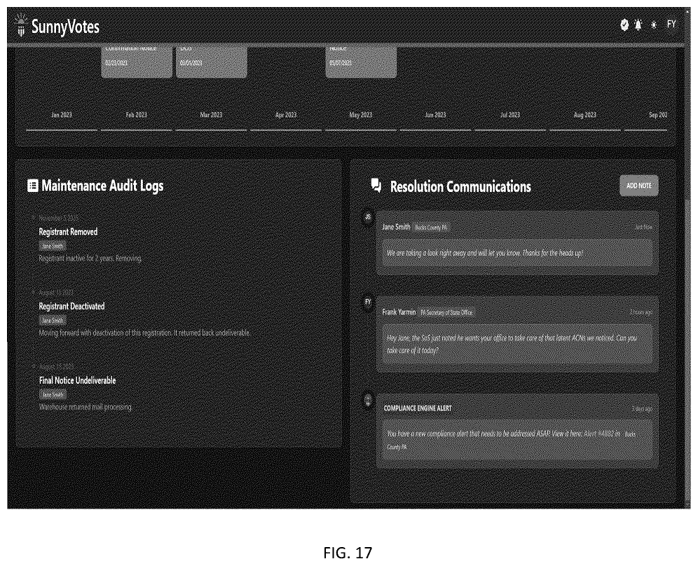

Referring to FIGS. 15-17, various drill down menus are depicted. As depicted in FIG. 15, this interface can provide a snapshot of various voter verification and list maintenance checks, such as citizenship, address, and age verification, along with national change of address information from that database. Each category displays the number of verifications conducted and their respective success rates. The report section lists individual voter identifications with compliance statuses, highlighting any issues like failed actions. Users can filter through compliant and discrepant entries and access detailed records for each voter to ensure compliance and resolve discrepancies effectively. Referring to FIG. 16, detailed timeline view is depicted for a specific voter's maintenance record for visually tracking status changes and key actions taken, such as mail returns, notice send attempts, escalations, and deactivations. Each step can be marked with a corresponding date and status indicator (e.g., successful, failed, escalated) for clear insight into the voter registration maintenance process. Below the timeline, tools for reviewing audit logs and adding notes for further resolution are available, supporting comprehensive case management. Referring to FIG. 17, detailed visibility into voter maintenance actions and communications is depicted. The maintenance audit logs section offers a chronological log of key updates, such as voter deactivation or removal due to inactivity to ensure traceable record-keeping. Adjacent to it, the resolution communications panel can facilitate direct messaging and alerts among officials, supporting collaborative problem-solving and prompt action on compliance issues. These features help election offices maintain thorough oversight and effective communication for resolving voter record concerns. These menus as depicted in FIGS. 15-17 can be accessed via the election officials deficiency alerts and reports portal 1308, in some embodiments.

Having described various systems and methods herein, certain embodiments can include, but are not limited to:

In a first aspect, a method for identifying one or more deficiencies in an election system, comprises: providing remote access over a network to a non-transitory storage device for updating information about an election in real time; retrieving the information in a non-standardized format dependent on one or more hardware and software platforms of at least one election data source database; converting, by a content server, the non-standardized format into the standardized format; storing the information about election data source records in the standardized format within the content server; retrieving one or more legal framework records and converting as the standardized format into the content server; generating one or more compliance rules; comparing the information in the standardized format with the one or more compliance rules to identify the one or more deficiencies in the election data source records; automatically generating a remedial message about the compared information of the election data source records by the content server after validating the information; and transmitting the remedial message to a first user over the network in real time.

A second aspect can include the method of the first aspect, wherein the first user is an election personnel.

A third aspect can include the method of the first or second aspect, wherein the remote access is provided by encrypted, and at least one of authorized, authenticated, or a combination thereof access via an API.

A fourth aspect can include the method of any one of the proceeding aspects, wherein the transmitted remedial message is cybersecured and limited.

A fifth aspect can include the method of any one of the proceeding aspects, wherein the content server confirms whether the first user has received and opened the remedial message.

A sixth aspect can include the method of any one of the proceeding aspects, further comprising, after a second predetermined period of time, retrieving updated information in the non-standardized format dependent on the hardware and software platform of each of the at least one election data source database; converting, by the content server, an updated non-standardized format into an updated standardized format, storing an updated standardized information about elections in the election data source records in the standardized format; comparing the information in the updated standardized format with the one or more compliance rules to identify the one or more deficiencies in an election data source; determining if the remedial message sent to the first user has resulted in corrective action; automatically generating a message about the elections by the content server if no corrective action taken by the first user in a predefined time frame; and transmitting the message to a second user being an election personnel over the network in real time regarding non-action by the first user to bring a deficient election record into compliance.

A seventh aspect can include the method of any one of the proceeding aspects, wherein the second user is a superior to the first user.

An eighth aspect can include the method of any one of the proceeding aspects, further comprising, after a second predetermined period of time, retrieving updated information in the non-standardized format dependent on the hardware and software platform of each of the at least one election data source database; converting, by the content server, an updated non-standardized format into an updated standardized format; storing an updated standardized information about elections in the election data source records in the standardized format; comparing the information in the updated standardized format with the one or more compliance rules to identify the one or more deficiencies in an election data source; determining if the remedial message sent to the first user has resulted in corrective action; and automatically recording and removing an alert if corrective action has been undertaken by the first user.

A ninth aspect can include the method of any one of the proceeding aspects, wherein the one or more deficiencies in the election system are determined before an election, during the election, or after the election.

A tenth aspect can include the method of any one of the proceeding aspects, wherein the election data source records during the election comprises at least one of mail ballot signatures, machine calibration, or a combination thereof.

An eleventh aspect can include the method of any one of the proceeding aspects, wherein the election data source records after the election comprises at least one of audit data, certification data, or a combination thereof.

A twelfth aspect can include the method of any one of the proceeding aspects, further comprising identifying the one or more deficiencies by comparing at least one voter verification data comprised in a poll book with at least one voter registration data to identify changes in voter qualifications.

A thirteenth aspect can include the method of any one of the proceeding aspects, wherein retrieving data from comprises using read-only transfers from the at least one election data source database into the content server.

A fourteenth aspect can include the method of any one of the proceeding aspects, wherein the election data source records comprises at least one voter record, which comprises at least about 10, about 100, about 1,000, about 10,000, about 100,000, or about 1,000,0000 individual voters.

A fifteenth aspect can include the method of any one of the proceeding aspects, wherein the transmitting the remedial message to the first user of at least one voter record in real time is no more than hourly, than daily, or weekly.

A sixteenth aspect can include the method of any one of the proceeding aspects, wherein a user is an election officer, an elected official, or a member of the general public.

A seventeenth aspect can include the method of any one of the proceeding aspects, wherein user's access to information within the election data source records in the standardized format varies on a user's position.

In an eighteenth aspect, an election system for maintaining election integrity in at least one jurisdiction, comprises: a content server configured to: receive information in a non-standardized format dependent on one or more hardware and software platforms from at least one election data source database containing information about elections in a non-standardized format, convert the non-standardized format into a standardized format, store the information about election data source records in the standardized format, compare the information in the standardized format with one or more compliance rules to identify one or more deficiencies in an election system, automatically generate a remedial message about a compared information of the election data source records by the content server after comparing the information, and transmit the remedial message to a first user comprising an election personnel over a computer network in real time.

A nineteenth aspect can include the election system of the eighteenth aspect, wherein after a first predetermined period of time, wherein the content server confirms whether the first user has received and opened the remedial message.

A twentieth aspect can include the election system of the eighteenth or nineteenth aspect, wherein, after a second predetermined period of time, retrieves an updated information in the non-standardized format dependent on the hardware and software platform of each of the at least one election data source database; converts, by the content server, an updated non-standardized format into an updated standardized format, and stores the updated standardized information about the election data source records in the standardized format; compares the information in the updated standardized format with the one or more compliance rules to identify the one or more deficiencies in an election system; determines if a remedial message sent to the first user has resulted in corrective action; automatically generates a remedial message about the elections by the content server if no corrective action taken by the first user; and transmits the remedial message to a second user comprising the election personnel over the computer network in real time regarding a non-action by the first user or creates a record if corrective action undertaken by the first user and removes an alert for the undertaken corrective action.

A twenty first aspect can include the election system of any one of the eighteenth to twentieth aspects, wherein the one or more deficiencies in the election system are determined before an election, during the election, or after the election.

A twenty second aspect can include the election system of any one of the eighteenth to twenty first aspects, wherein the election data source records during the election comprises at least one of audit data, certification data, or a combination thereof.

A twenty third aspect can include the election system of any one of the eighteenth to twenty second aspects, wherein the election data source records after the election comprises at least one election tabulation record.

A twenty fourth aspect can include the election system of any one of the eighteenth to twenty third aspects, further comprising identifying the one or more deficiencies by comparing at least one voter verification data comprised in a poll book with at least one voter registration data to identify changes in voter qualifications.

A twenty fifth aspect can include the election system of any one of the eighteenth to twenty fourth aspects, wherein retrieving the information in a non-standardized format comprises using read-only transfers.

A twenty sixth aspect can include the election system of any one of the eighteenth to twenty fifth aspects, wherein the information comprises at least one voter record, which comprises at least about 10, about 100, about 1,000, about 10,000, about 100,000, or about 1,000,0000 individual voters.

A twenty seventh aspect can include the election system of any one of the eighteenth to twenty sixth aspects, wherein the transmitting the remedial message to the first user of the at least one voter record in real time is no more than hourly, than daily, or weekly.

A twenty eighth aspect can include the election system of any one of the eighteenth to twenty seventh aspects, wherein a user is an election officer, an elected official, or a member of the general public.

A twenty ninth aspect can include the election system of any one of the eighteenth to twenty eighth aspects, wherein the one or more compliance rules are inputted in a standard format from one or more legal framework records.

In a thirtieth aspect, an election system for maintaining election integrity in at least one jurisdiction, comprises: a content server, wherein the content server comprises: a data mapping and standards engine to receive information in a non-standardized format dependent on one or more hardware and software platforms from at least one election data source database containing information about elections in a non-standardized format, and convert the non-standardized format into a standardized format, a standardized source database to store the information about election data source records in the standardized format, a compliance rules engine to compare the information in the standardized format with one or more compliance rules to identify one or more deficiencies in an election system, a compliance deficiency database to store one or more identified deficiencies in the election system, and a compliance deficiency alerts and reporting engine to automatically generate a remedial message about the one or more identified deficiencies, and transmit the remedial message to a first user comprising an election personnel over a computer network in real time.

A thirty first aspect can include the election system of the thirtieth aspect, wherein after a first predetermined period of time, wherein the content server confirms whether the first user has received and opened the remedial message.

A thirty second aspect can include the election system of the thirtieth or thirty first aspect, wherein, after a second predetermined period of time, the data mapping and standards engine retrieves an updated information in the non-standardized format dependent on the hardware and software platform of each of the at least one election data source database, and converts the updated non-standardized format into an updated standardized format; the standardized source database to store the updated standardized information about the election data source records in the standardized format; the compliance rules engine to compare the information in the updated standardized format with the one or more compliance rules to identify the one or more deficiencies in an election system; the compliance deficiency alerts and reporting engine to determine if a remedial message sent to the first user has resulted in corrective action; and the compliance deficiency alerts and reporting engine to automatically generate a remedial message about the elections by the content server if no corrective action taken by the first user, and transmit the remedial message to a second user comprising the election personnel over the computer network in real time regarding a non-action by the first user or creates a record if corrective action undertaken by the first user and removes an alert for the undertaken corrective action.

A thirty third aspect can include the election system of any one of the thirtieth to thirty second aspects, wherein the one or more deficiencies in the election system are determined before an election, during the election, or after the election.

A thirty fourth aspect can include the election system of any one of the thirtieth to thirty third aspects, wherein the election data source records during the election comprises at least one of audit data, certification data, or a combination thereof.

A thirty fifth aspect can include the election system of any one of the thirtieth to thirty fourth aspects, wherein the election data source records after the election comprises at least one election tabulation record.

A thirty sixth aspect can include the election system of any one of the thirtieth to thirty fifth aspects, further comprising identifying the one or more deficiencies by comparing at least one voter verification data comprised in a poll book with at least one voter registration data to identify changes in voter qualifications.

A thirty seventh aspect can include the election system of any one of the thirtieth to thirty sixth aspects, wherein retrieving the information in a non-standardized format comprises using read-only transfers.

A thirty eighth aspect can include the election system of any one of the thirtieth to thirty seventh aspects, wherein the information comprises at least one voter record, which comprises at least about 10, about 100, about 1,000, about 10,000, about 100,000, or about 1,000,0000 individual voters.

A thirty ninth aspect can include the election system of any one of the thirtieth to thirty eighth aspects, wherein the transmitting the remedial message to the first user of the at least one voter record in real time is no more than hourly, than daily, or weekly.

A fortieth aspect can include the election system of any one of the thirtieth to thirty ninth aspects, wherein a user is an election officer, an elected official, or a member of the general public.

A forty first aspect can include the election system of any one of the thirtieth to fortieth aspects, wherein the one or more compliance rules are inputted into the compliance rules engine in a standard format from one or more legal framework records.

In a forty second aspect, an election compliance engine comprises: a data mapping and standards engine to receive information in a non-standardized format dependent on one or more hardware and software platforms from at least one election data source database containing information about elections in a non-standardized format, and convert the non-standardized format into a standardized format, a standardized source database to store the information about election data source records in the standardized format, a compliance rules engine to compare the information in the standardized format with one or more compliance rules to identify one or more deficiencies in an election system, a compliance deficiency database to store one or more identified deficiencies in the election system, and a compliance deficiency alerts and reporting engine to automatically generate a remedial message about the one or more identified deficiencies, and transmit the remedial message to a first user comprising an election personnel over a computer network in real time.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for identifying one or more deficiencies in an election system, comprising:
providing remote access over a network to a non-transitory storage device for updating information about an election in real time;
retrieving the information in a non-standardized format dependent on one or more hardware and software platforms of at least one election data source database;
converting, by a content server, the non-standardized format into the standardized format;
storing the information about election data source records in the standardized format within the content server;
retrieving one or more legal framework records and converting as the standardized format into the content server;
generating one or more compliance rules;
comparing the information in the standardized format with the one or more compliance rules to identify the one or more deficiencies in the election data source records;
automatically generating a remedial message about the compared information of the election data source records by the content server after validating the information; and
transmitting the remedial message to a first user over the network in real time.

2. The method of claim 1, wherein the first user is an election personnel.

3. The method of claim 1, wherein the remote access is provided by encrypted, and at least one of authorized, authenticated, or a combination thereof access via an API.

4. The method of claim 1, wherein the transmitted remedial message is cybersecured and limited.

5. The method of claim 1, after a first predetermined period of time, wherein the content server confirms whether the first user has received and opened the remedial message.

6. The method of claim 5, further comprising, after a second predetermined period of time, retrieving updated information in the non-standardized format dependent on the hardware and software platform of each of the at least one election data source database;
converting, by the content server, an updated non-standardized format into an updated standardized format,
storing an updated standardized information about elections in the election data source records in the standardized format;
comparing the information in the updated standardized format with the one or more compliance rules to identify the one or more deficiencies in an election data source;
determining if the remedial message sent to the first user has resulted in corrective action;
automatically generating a message about the elections by the content server if no corrective action taken by the first user in a predefined time frame; and
transmitting the message to a second user being an election personnel over the network in real time regarding non-action by the first user to bring a deficient election record into compliance.

7. The method of claim 6, wherein the second user is a superior to the first user.

8. The method of claim 5, further comprising, after a second predetermined period of time, retrieving updated information in the non-standardized format dependent on the hardware and software platform of each of the at least one election data source database;
converting, by the content server, an updated non-standardized format into an updated standardized format;
storing an updated standardized information about elections in the election data source records in the standardized format;
comparing the information in the updated standardized format with the one or more compliance rules to identify the one or more deficiencies in an election data source;
determining if the remedial message sent to the first user has resulted in corrective action; and
automatically recording and removing an alert if corrective action has been undertaken by the first user.

9. The method of claim 1, wherein the one or more deficiencies in the election system are determined before an election, during the election, or after the election.

10. The method of claim 9, wherein the election data source records during the election comprises at least one of mail ballot signatures, machine calibration, or a combination thereof.

11. The method of claim 9, wherein the election data source records after the election comprises at least one of audit data, certification data, or a combination thereof.

12. The method of claim 9, further comprising identifying the one or more deficiencies by comparing at least one voter verification data comprised in a poll book with at least one voter registration data to identify changes in voter qualifications.

13. The method of claim 1, wherein retrieving data from comprises using read-only transfers from the at least one election data source database into the content server.

14. The method of claim 1, wherein the election data source records comprises at least one voter record, which comprises at least about 1,000,0000 individual voters.

15. The method of claim 14, wherein the transmitting the remedial message to the first user of at least one voter record in real time is no more than hourly.

16. The method of claim 1, wherein a user is an election officer, an elected official, or a member of the general public.

17. The method of claim 16, wherein user's access to information within the election data source records in the standardized format varies on a user's position.

18. An election system for maintaining election integrity in at least one jurisdiction, comprising:
a content server configured to:
receive information in a non-standardized format dependent on one or more hardware and software platforms from at least one election data source database containing information about elections in a non-standardized format,
convert the non-standardized format into a standardized format,
store the information about election data source records in the standardized format,
compare the information in the standardized format with one or more compliance rules to identify one or more deficiencies in an election system,
automatically generate a remedial message about a compared information of the election data source records by the content server after comparing the information, and
transmit the remedial message to a first user comprising an election personnel over a computer network in real time.

19. The election system of claim 18, wherein, after a second predetermined period of time,
retrieves an updated information in the non-standardized format dependent on the hardware and software platform of each of the at least one election data source database;
converts, by the content server, an updated non-standardized format into an updated standardized format,
stores the updated standardized information about the election data source records in the standardized format;
compares the information in the updated standardized format with the one or more compliance rules to identify the one or more deficiencies in an election system;
determines if a remedial message sent to the first user has resulted in corrective action;
automatically generates a remedial message about the elections by the content server if no corrective action taken by the first user; and
transmits the remedial message to a second user comprising the election personnel over the computer network in real time regarding a non-action by the first user or creates a record if corrective action undertaken by the first user and removes an alert for the undertaken corrective action.

20. An election system for maintaining election integrity in at least one jurisdiction, comprising:
a content server, wherein the content server comprises:
a data mapping and standards engine to receive information in a non-standardized format dependent on one or more hardware and software platforms from at least one election data source database containing information about elections in a non-standardized format, and convert the non-standardized format into a standardized format,
a standardized source database to store the information about election data source records in the standardized format,
a compliance rules engine to compare the information in the standardized format with one or more compliance rules to identify one or more deficiencies in an election system,
a compliance deficiency database to store one or more identified deficiencies in the election system, and
a compliance deficiency alerts and reporting engine to automatically generate a remedial message about the one or more identified deficiencies, and transmit the remedial message to a first user comprising an election personnel over a computer network in real time.
